(19) United States
(12) Patent Application Publication
(10) Pub. No.: US 2018/0300046 A1
(43) Pub. Date: Oct. 18, 2018

(54) IMAGE SECTION NAVIGATION FROM MULTIPLE IMAGES

(71) Applicant: International Business Machines Corporation, Armonk, NY (US)

(72) Inventors: Munish Goyal, Yorktown Heights, NY (US); Wing L. Leung, Austin, TX (US); Sarbajit K. Rakshit, Kolkata (IN); Kimberly Greene Starks, Nashville, TN (US)

(21) Appl. No.: 15/486,034

(22) Filed: Apr. 12, 2017

(51) Int. Cl. G06F 3/0484; G06K 9/00; G06F 17/30; G06N 99/00

(52) U.S. Cl. CPC G06F 3/04847; G06F 3/04845; G06N 99/005; G06F 3/04842; G06F 17/30265; G06K 9/00288

(57) ABSTRACT

A cognitive system and method and computer program product for recommending editing recommendations to a digital image. The computer implemented method includes receiving data representing a user's selection of an object of interest within the current digital image, and a user's preference relating to editing and replacing the selected image object within a current digital image. The method cognitively maps the user's object of interest selection within the current image and the received user editing and replacing preferences to historical user editing selections and user actions associated with user selected objects of interest within digital images taken in the past. Responsive to the mapping, the methods identify a plurality of candidate digital images having similar and/or relevant objects of interest therein. One or more identified candidate digital image section having a relevant object of interest therein are identified for overlay display within the digital image.

### FIELD

Various embodiments of the present invention relate to image processing relating to digital image processing, and more specifically, to a method and apparatus for enabling operator/editors to navigate amongst image sections of a digital image, e.g., a photograph or video frame(s), from one image section to another section without changing the entire image.

### BACKGROUND

Currently, a camera device such as a stand-alone camera or one included as part of a mobile device, is configurable to captures a single or multiple photographs at a time. Multiple photographs are taken to ensure a picture quality of the subject matter that is preferred. For example, in one photograph, a subject's eyes were closed when the photograph was captured. So a user may retake the photograph, again and again until they get the best shot. Using “burst mode” functionality available in many cameras, multiple images are captured in rapid succession as known in the camera arts and related image capture technologies.

Currently there exists a problem with obtaining best images of multiple people or subjects, e.g., a group and moving subject photography, where multiple subjects or moving subjects are present in a photograph. For example in one scenario, subject A may be captured with closed eyes, whereas in another photograph subject B was captured with a closed eye and subject A's eye were open. The issue becomes more pronounced with more subjects in the photograph. There may not be any photograph where each of the participating subjects are in the preferred photogenic quality (i.e. eyes open, arms down, looking toward the camera or any other attributes that the user of the camera thinks makes good picture quality).

In another requirement, the camera operator or photo editor may want to compare a particular “image object”, e.g., an object in an image or a section of an image from one photograph to another photograph captured using burst mode. The operator/editor may not want to change the entire photograph, but wants to see a particular section of the photograph without disturbing other views of the object or section of the photograph they are interested in.

### SUMMARY

The present invention provides a method, computer-implemented system, and computer program product for editing a digital image. The method includes: receiving, at a processor device, data representing a user's selection of an object of interest within a current digital image; receiving, at a processor device, data representing the user's preference relating to editing or replacing the selected object of interest within the current digital image; mapping, at the processor device, the user's object of interest selection within the current digital image and the received user editing and replacing preferences to historical user editing selections and user actions associated with user selected objects of interest within digital images taken in the past; responsive to the mapping, identifying, by the processor, a plurality of candidate digital images having similar and/or relevant objects of interest therein; and generating, for display within the digital photograph, one or more identified candidate digital image section having a relevant object of interest therein, each the one or more candidate digital image sections being overlayed at a location corresponding to the user selected object of interest within the current digital image

Other embodiments of the present invention include a computer-implemented system and a computer program product which implement the above-mentioned method.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 depicts an example of a burst mode or continuous shot mode photography or video frames to which methods of the present invention may be implemented in one embodiment;

FIG. 2 schematically shows an exemplary computer system/mobile device which is applicable to implement the embodiments of the present invention;

FIG. 3 depicts an example embodiment of a method providing a cognitive ability of the system of FIG. 2 for ingesting data relating to past historical user actions and building a learned recommendation model;

FIG. 4 generally depicts an editing/replacement recommending process used to identify candidate digital photographs and recommend or suggest edits or actions to take with respect to candidate digital images in one embodiment;

FIG. 5 shows one embodiment of a display interface displaying a current digital image and displaying additional corresponding navigation toolbar overlayed on corresponding user selected image sections;

FIG. 6 shows an example display of the image object navigation block that will provide an option for an operator/editor to display each candidate digital photographs as an overlay around the selected object of interest;

FIG. 7 shows an example display of a photograph of a group of people, and the cognitive program to visually recognize individual subjects in an example implementation; and

FIG. 8 is an exemplary block diagram of a computer system in which processes involved in the system, method, and computer program product described herein may be implemented.

### DETAILED DESCRIPTION

Embodiments will now be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As referred to herein, a digital image subject to the processing described herein, may be embodied as a digital photograph or a video frame of a video recording or animation.

One embodiment of the present invention is directed to an enhancement for cameras that capture several images in a burst mode, a continuous high-speed shooting mode. In burst mode, a camera takes many still shots (e.g., tens or hundreds of shots) in one quick succession. Burst shot photos are typically stored on the device's internal memory.

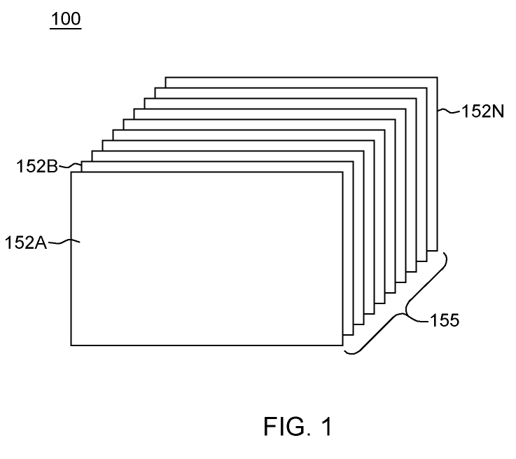

FIG. 1 conceptually depicts a “burst” or continuous shot mode photography 100. In such method, a digital camera device captures multiple photographs 152A, 152B, . . . , 152N in a short span of time. For example, in one type of burst mode, a digital camera might capture ten photos 155 in five seconds, while another type may obtain twenty photos in two seconds in another type of burst mode, etc. There will be a time lapse from one photograph to another photograph. The position, orientation, expression of an object within the image may change from one image to another image in the photograph groups. While the system and methods described herein may be applied to burst mode photographic images, they are readily applicable to a single digital image, a video or recording of an animation that can be processed as individual video frames or animation frames.

In one aspect, a system and methods are described herein providing a cognitive ability to suggest edits, e.g., for improving the quality of the photograph by replacing image sections or objects therein whether taken in burst mode or not. In one aspect, cognitive logic is employed to automatically determine how to obtain multiple candidate photographs having candidate image sections and/or objects of interest therein, and further navigate and modify a digital photograph or video/animation frame by replacing an image section or object of interest within the photograph with those of a candidate photograph or video frame, e.g., in an effort to enhance or improved desired aspects of the image or objects therein.

Thus, a cognitive system is further provided to make recommendations for augmenting/replacing an image section or object of interest based upon a prior knowledge of the user. This prior knowledge is used to train a machine learning system or model to make recommendations for editing/replacing portions of a current photographic or video frame(s) image. Thus, for example, various recommendations for editing/replacing the photograph (or portion thereof) with identified similar (or most relevant) image content, may be automatically presented to the user based upon that user's prior historical usage, e.g., how that user has edited/replaced similar images in photographs in the past. A generated option(s) or recommendation(s) using the cognitive ability of the system may be presented to the user with suggestions to take any action with respect to the digital image.

In one embodiment, the cognitive ability and learning aspect is not only with respect to the user's preferences for taking and editing photographs, but may be also or alternatively be based on that user's further social interactions, e.g., the way the user interacts with social media web-sites, and/or based on actions the user takes or applications the user opens on the device having the camera. For example, if it has been learned in the past visited web-sites or social media sites or feeds that the user likes a particular type of red ball, the cognitive system will search other image content sources and automatically suggest an option to add a picture of a red ball to the current photograph, or replace a red ball in the current photograph with a particular type of red ball taken from an image of another source. The cognitive capabilities of the system enables learning from a user's past to predict a manner in which to edit the photograph based on the historical knowledge of the user.

To determine the best recommendation, the cognitive system learns over time by comparing segment of the object within the photogeraph or video frame(s) to be replaced with segments that are available from the various other content sources. The system uses object recognition to determine the segments to be compared and, and in one embodiment, uses the tags available from each of the segments (both the source object) and the candidate objects to determine that the objects are similar.

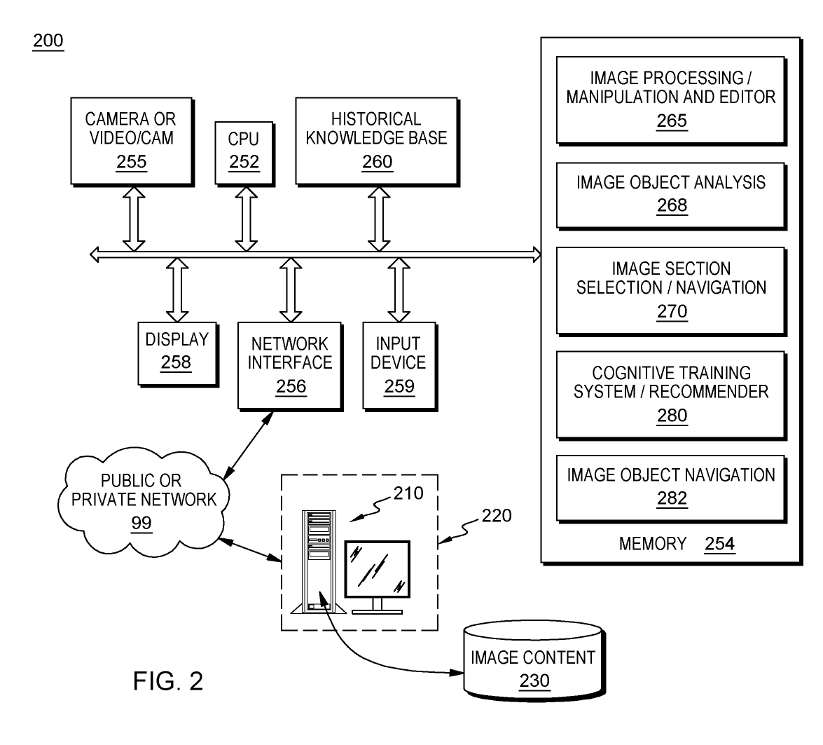

Referring now to FIG. 2, there is depicted a computer system 200 providing a cognitive ability for editing/replacing image sections of photographs or video frame(s). In some aspects, system 200 may include a computing device, a mobile device, or a server. In some aspects, computing device 200 may include, for example, personal computers, laptops, tablets, smart devices, smart phones, smart wearable devices, smart watches, or any other similar computing device.

Computing system 200 includes at least a processor 252, a memory 254, e.g., for storing an operating system and program instructions, a network interface 256, a display device 258, an input device 259, and any other features common to a computing device. In some aspects, computing system 200 may, for example, be any computing device that is configured to communicate with a social media web-site 220 or web- or cloud-based server 210 over a public or private communications network 99. Further, shown as part of system 200 is an image capture device such as a digital camera 255 and/or video recording device (e.g., a videocam) and assorted functionality, e.g., for editing photographs or video/video frames.

In one embodiment, as shown in FIG. 2, a device memory 254 stores program modules providing the system with cognitive abilities for suggesting ways for image processing/editing of photographs or video frame(s). For example, an image processing/manipulation and editing program 265 as known in the art is provided for basic photograph/or video frame image navigation and editing. An image object analysis program 268 is provided for analyzing photographs and objects within multiple images, e.g., other images taken in a burst mode or group of video frames. The image object analysis program 268 provides additional cognitive ability of system 200 by running methods for searching and identifying similar image section or objects selected within a current photograph to be edited/replaced in other identified photographs identified from or located within web-sites, social media sites visited by the user, a knowledgebase 260 or other private or publically available data corpus, or like source 230 having image content. In one embodiment, the user sets the image section or object to be edited/replaced and sets preferences for a scope and breadth of searching and identifying other identified images/objects.

Program modules further include an image section/object selection navigation tool generator 270, and image object navigation editor program 282 for displaying at system display device an overlay of image object navigation tools onto displayed photograph or video frame(s) images having objects to be edited or replaced. Each image object navigation tool enables user navigation and selection of other various photographic/video frame images having desired image sections/objects that can be selected by the user to replace the image section or object of a current selected photograph without changing a view of the underlying current photograph.

In FIG. 2, processor 252 may include, for example, a microcontroller, Field Programmable Gate Array (FPGA), or any other processor that is configured to perform various operations. Processor 252 may be configured to execute instructions as described below. These instructions may be stored, for example, in memory 254.

Memory 254 may include, for example, non-transitory computer readable media in the form of volatile memory, such as random access memory (RAM) and/or cache memory or others. Memory 254 may include, for example, other removable/non-removable, volatile/non-volatile storage media. By way of non-limiting examples only, memory 254 may include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Network interface 256 is configured to transmit and receive data or information to and from a social media web-site server 210, e.g., via wired or wireless connections. For example, network interface 256 may utilize wireless technologies and communication protocols such as Bluetooth®, WIFI (e.g., 802.11a/b/g/n), cellular networks (e.g., CDMA, GSM, M2M, and 3G/4G/4G LTE), near-field communications systems, satellite communications, via a local area network (LAN), via a wide area network (WAN), or any other form of communication that allows computing device 200 to transmit information to or receive information from the server 210.

Display 258 may include, for example, a computer monitor, television, smart television, a display screen integrated into a personal computing device such as, for example, laptops, smart phones, smart watches, virtual reality headsets, smart wearable devices, or any other mechanism for displaying information to a user. In some aspects, display 258 may include a liquid crystal display (LCD), an e-paper/e-ink display, an organic LED (OLED) display, or other similar display technologies. In some aspects, display 58 may be touch-sensitive and may also function as an input device.

Input device 259 may include, for example, a keyboard, a mouse, a touch-sensitive display, a keypad, a microphone, or other similar input devices or any other input devices that may be used alone or together to provide a user with the capability to interact with the computing device 200.

With respect to the cognitive ability of computer system 200 for making photo/video editing recommendations, the system 200 includes: a knowledge base 260 configured for storing preferences and past (historical) actions for a particular user. Besides correlating users preferences/actions with respect to digital photographic/video editing, further correlations are made to other user actions taken, such as actions taken and commentary entered by that user in social web-sites visited by that user or that user's social web-site feeds. In one embodiment, a cognitive training system/recommender module 280 builds the knowledgebase based on changes/edits made by the user to photographs or video frame(s) over time, and implemented to assist in making recommendations using a trained recommender model based on the accumulated knowledge in knowledgebase 260. In one embodiment, this knowledgebase 260 may be local to the computer or mobile device system 200, or otherwise, such knowledgebase 260 may be located on a server 210, in a network, e.g., a cloud.

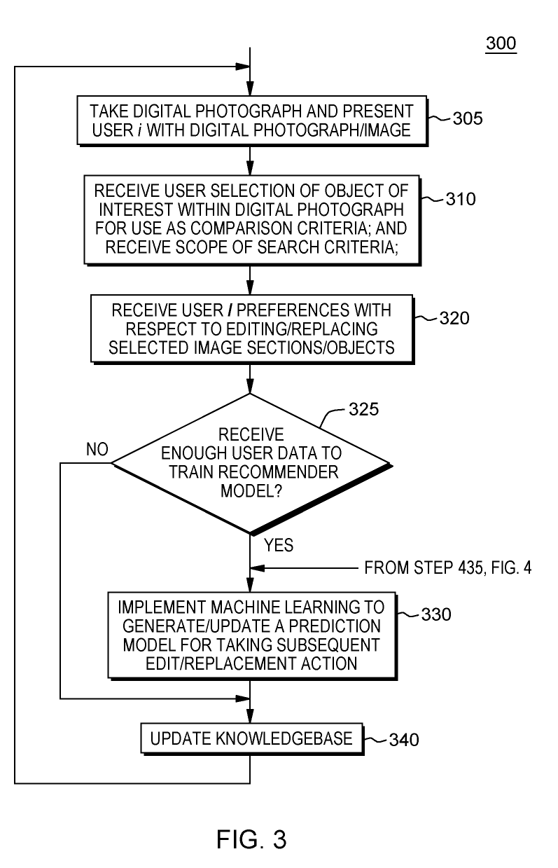

FIG. 3 depicts an example embodiment of a method 300 for ingesting data relating to past historical user actions and building a learned recommendation model for providing a cognitive ability of the system of FIG. 2. At a first step 305, a user takes a digital photograph/video and in response, and method is triggered to store the digital image/video in the device memory. Via the device display, the user may be presented with the new/current digital photograph or video frame(s) image for viewing/editing, via a viewer and/or editor program.

At 310, the system generates a display of entry field and/or menu choices for enabling user input or selection of a comparison criteria for making recommendations for the new photograph/video taken. This method includes, at step 310, a receipt of a user input specifying or selecting an area within the digital photograph or video frame including an object of interest for replacement and/or addition. The system may further receive a user preference including a breadth of search for the system to search out candidate image objects for replacement in the new photograph/video frame image, e.g., the burst of photos stored in the device's local memory or successive video frames of the current video frame image, a specific corpus of image content, a social media web-site, etc. when finding candidate image objects to be edited and/or replaced based on the set comparison criteria.

Then, continuing to 320, further viewing and image editing preferences are obtained as set by the user for editing operations performed with respect to the photograph or video frame(s). For example, the user may tend to always apply red-eye reduction to all face objects, and/or may always open a particular editing program that the user uses to overlay a hand-drawn logo or indicia onto the photograph image/video frame(s). In one embodiment, the system records the user selection of a section or object of interest within the image, e.g., a face, and then records editing actions such as applying red-eye reduction. The user may always look in his/her social media account to look for other photographs having the same object for potential replacement. The user may further always post the digital photograph/video in a social media website. All these actions with respect to editing/replacing image sections/objects of a photograph are received into the system at 320.

In one embodiment, in cooperation with methods of image recognition processing of image object analysis block 268, a particular object within the photograph may be automatically or manually selected for editing or replacement. The image “objects” to be reworked or replaced may be selected by drawing lines around the image objects of focus. The area can be captured with a user's finger, stylus or using standard selection tools available in the image processing/manipulation and editor software. Alternately, the image object analysis block 268 software perform methods to automatically allow sectioning of an image based on minimal overlapping edge detection. This may be specified in a user setting for setting a boundary for a selected object of interest, e.g., an edge to be detected of the object selected by the user.

In one embodiment, image object analysis module 268 is invoked at system 200 to analyze the boundary lines, and recognize the image object boundary as the object or area selected. As the drawn line and image object boundary may not be same, this module will identify the closed image object boundary around the drawn boundary.

In one embodiment, the automatic selection could be achieved through tagging of individuals, for example, whose eyes are closed, who has red eye, who is not looking at the camera, etc. In this embodiment, the tag is determined by references to that user's social media contacts systems, social media web-site, or other systems/cources where individuals are identified. That is, as users post photographs/videos and tags images, the machine learning processes perform an ingestion and learning so that images of people can be determined and automatically tagged. For the case of animation or video content, to determine the best recommendation, the system 200 will learn over time by comparing the segment of the video frame to be replaced with segments that are available from the various sources. The system uses object recognition to determine the segments to be compared and uses the tags available from each of the segments (both the source object) and the candidate objects to determine that the objects are similar.

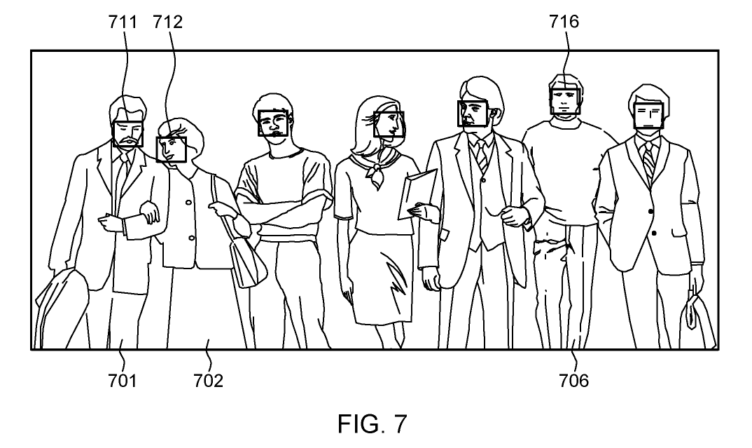

FIG. 7 shows an example digital photograph subject to the image processing provided via the system 200 in which, for a given an image, a cognitive program is run to identify to select a section of an image representing a specific object of interest, e.g., a person or subject's face. IBM's Watson™ AlchemyVision website provides such service in an application programming interface (API). The example image 700 of FIG. 7 demonstrates a photograph of a group of people, and the cognitive program to visually recognize individual subjects 701, 702, . . . , 706 in the image, as well as generate corresponding outlines 711, 712, . . . , 716 overlayed with the image to select the “face” of these subjects which is then used to perform the visual recognition.

Thus, in view of FIG. 2, given a section of an image, the cognitive program (image object analysis block 268) can identify the object of interest in the image and subsequently identify the same object in other photographs/video frames, e.g., in other image sources. This cognitive capability is really another use of the general cognitive capability of recognizing an object. This example illustrates that for any outlined faces that is provided to the cognitive system, methods are invoked for identifying the individual and then identifying the same individual in other candidate photographs, e.g., from a corpus. In one embodiment, persons in the photograph can be identified via social and mobile based contacts, social media or other systems that store photo contacts known and unknown to the user. It is understood that, while the example uses “people” as the object, cognitive programs (such as IBM Watson™ AlchemyVision) can be configured to recognize a majority of animate or inanimate objects/conditions in general.

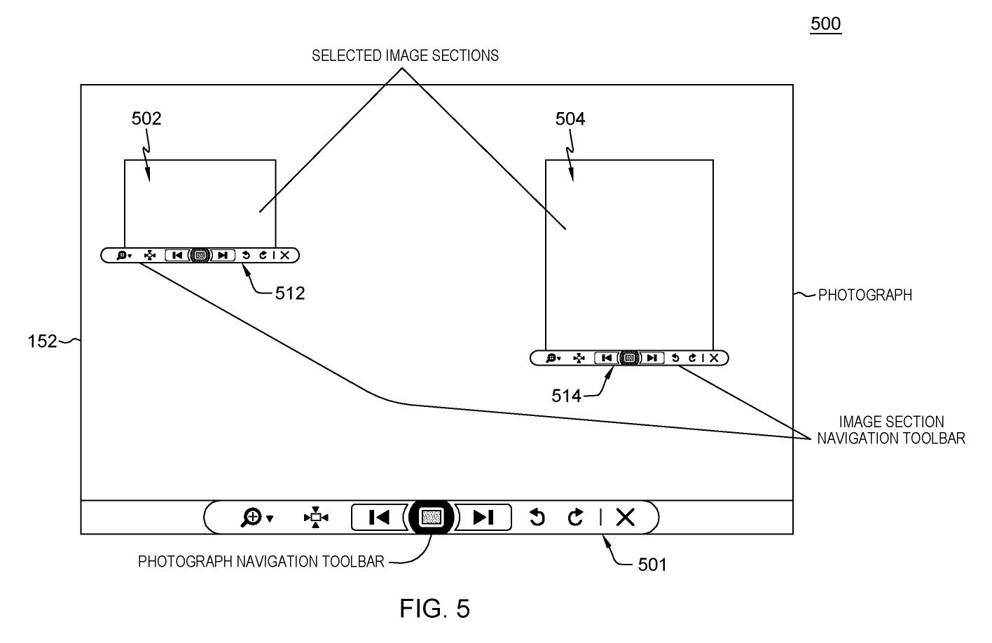

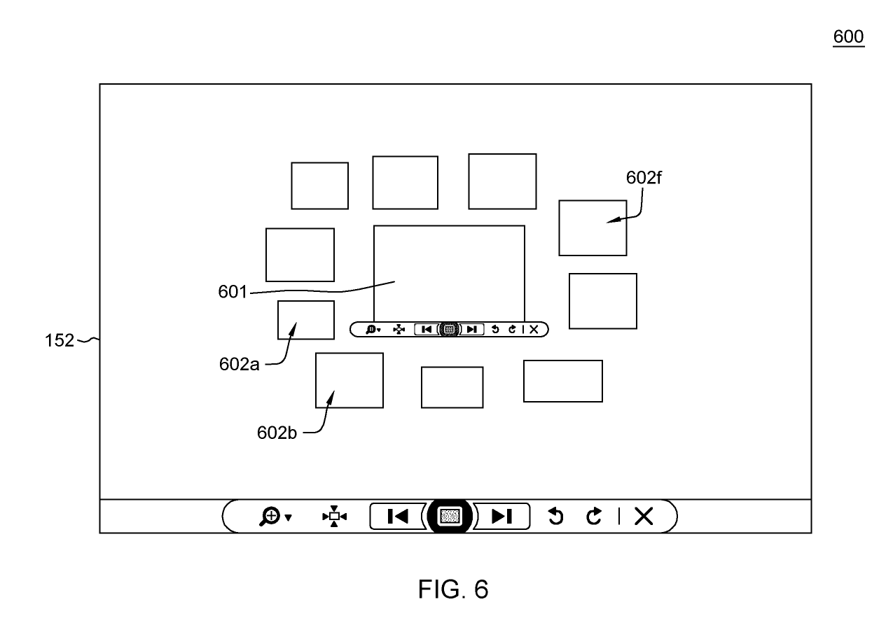

Thus, the cognitive capabilities provided with system 200 are applied with use of an editing overlay system to provide an automatic overlay of the candidate images found. Using the above example, system 200 a user can take a burst-mode photographs of the picture 152 or successive video frames of a video recording, and automatically identify and highlight the individuals (in this example, their faces specifically), and provide an overlay image (as shown in FIGS. 5 and 6) for the user to quickly create one or more desired composite photographs/video frames.

Returning to FIG. 3 at 325, a decision is made as to whether there is enough data to train a recommender model for use in presenting suggestions for editing digital images taken by that user. If not enough data is received to train the model, the system continues to update the knowledgebase to enter the set user preferences and/or actions take with the particular digital photograph or video frame(s). Then, the system returns to step 305, FIG. 3 to continue recording further actions taken by the user with respect to other new photographs/video taken by repeating steps 305-325 until the model can be built for that user. That is, at 325, if it is determined that there is enough data for training and using the recommender model, then the process will proceed to step 330 to implement machine learning technique at the cognitive model trainer module 280 to generate/update a mapping that can be used to map current user selections to candidate object editing and/or replacement suggestions/recommendations to the user for new digital photographs/video taken. In one embodiment, such machine learning algorithms may be invoked in the “PAIRS” scalable geo-spatial data analytics platform available from International Business Machines, Corp. (IBM TJ Watson Research Center Yorktown Heights, N.Y.).

Then, at 340, the knowledgebase stores all updates with respect to the particular editing/replacing actions taken of any particular image section(s)/object(s) of interest. The system then returns to 305 to repeat method for continuously training the model, over time, whenever further photographs/video and corresponding editing/replacement actions are subsequently taken.

Generally, over time, as the user takes pictures and makes edits to them, the cognitive training/recommender system 280 implements machine learning techniques that ingest, reason and learn the user's preferences (e.g., types of edits made to photographs/video frames) which are stored in the knowledgebase and used for mapping to object editing recommendations. In one embodiment, over time, the selection of the image(s) that require ‘work’ can be achieved through the system's historical references. Once a pattern of selection from the user is determined based on historical information accessed from the knowledgebase 260, the system 200 automatically presents available image editing and/or replacement options to the user via display interface 258 As the system learns the preferences of the user the versions presented will be tailored to their selection and quality needs. It is understood that, over time, the image set presented may change as the system learns which types of images and their make up the user is most likely to select.

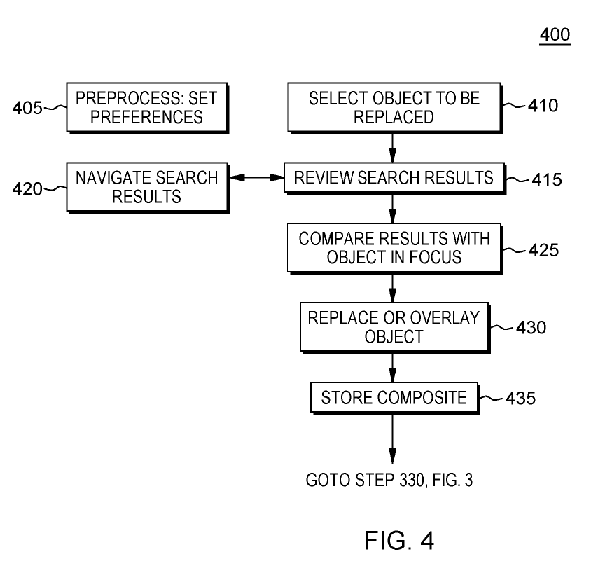

FIG. 4 generally depicts use of the cognitive editing/replacement recommending process 400 implemented at computing device 200 and used to recommend or suggest edits or actions to take with respect to a current digital photograph (or video frame of a video recording) taken by the device in one embodiment.

In the exemplary embodiment, computer system 200 and particularly the cognitive system 280 uses the trained recommender model for determining a best recommendation for photographic editing based on what the system has learned over time. After a photograph is taken, a first step 405 is a preprocessing step implemented for setting preferences: including user selection, via the display interface, of an object of interest to be edited or replaced in a current photograph. This includes, inputting, at 410, a user selection of an object to replace from a current photograph selected for editing, e.g., to enhance or correct the image, or to add to and form a composite digital image. While the processing herein is described herein below with reference to a digital photographic image, it is understood that the described methods are applicable for processing a video frame image(s) of a video recording or animation.

In one embodiment, additional preferences are set as a comparison criteria for making recommendations for the new photograph taken, e.g., automatically find an image for a selected or tagged person's face having “eyes open”. Additional preference set by the user and received at system 200 may include a scope of search setting for identifying objects in other photographs for use in replacing a selected object in a current digital photograph. For example, for a scope of search preference setting, the system may receive an input that similar objects selected for replacement are only to be found in the photographic burst stored a local memory of the device, or an associated local corpus, or as another example, that similar objects selected for replacement are additionally to be found at one or more various social media web-sites or social media feeds accessed by that user. Additional preference entered may be a criteria to overlay a specified image object within the current digital photograph. An additional input is a user preference to set an amount of options to for the system to suggest or recommend. based, e.g., a number of image objects or sections to invoke the model to find candidate replacements for. A further user preference may include a textual description, or a selected tag, relating to an object of interest, rather than receiving a user selection physically entered via the user interface.

Then, at 415, the trained recommending model is invoked based on the selected object of interest in the image and received user preference settings. The trained model analyses the current user selections and maps to historical content from the knowledgebase in the form of past user inputs, user preferences associated with past user actions taken and/or a user's past editing, replacement and other preformed actions of photographic images and image objects taken by that user Based on the mapped historical preferences, the system the method then initiates a search of other image sources (e.g., data corpus, web-site) based on the entered scope of search criteria, to find candidate images having similar or relevant image objects to recommend for editing/replacement of the current selected image section/object. The identified candidate images may further be specified to be overlayed, i.e., added to the current selected photograph. As a result, the system invokes search methods to identify object images from image sources than can be recommended via the display to the user to replace (or add) the selected section/object of the selected image at 415.

That is, once the appropriated required image object is identified, the recommender module will search for other photographs in a photo gallery, in the cloud or on a server or in social media web-site to find versions of same image objects based on the user's preference setting as to a breadth or scope of an image object similarity search. Continuing, at 420, the user may navigate to and/or scroll between identified candidate image objects, e.g., via a respective generated editing tool to be overlayed on the image as described herein below. In this manner, between steps 415, 420 selected candidate objects for replacement and/or overlay within the current photograph image can be reviewed for the user to make comparisons without changing the original photograph.

In one embodiment, in the case of burst mode photographs, using boundary selections over any photograph in the burst, the system 200 may identify the image sections, and can navigate the same image selection from one photograph 152A to another photograph 152B, . . . , 152N, e.g., that was captured in the burst.

At any time, via selection of a particular candidate image in focus, the current digital photograph may be edited to replace the selected object with the selected candidate image object. Then, at 430, the candidate image object from the image source is selected, and a new composite image having the replacement/overlayed image object is generated for display and stored in the device memory at 435, FIG. 4. The actions take by the user are then used to update the recommender model and the knowledgebase 260, e.g., by returning to FIG. 3, step 330.

In one particular aspect, an operator/editor (any user) can select a particular photograph image, e.g., from a photo burst, via a navigation tool bar 501 providing basic scrolling/editing functions of a photograph 500 displayed via a display editor tool display as shown in FIG. 5. Once a photograph 152 is selected from a collection of photographs, an operator/editor will have the option to select one or more image objects from the photograph according to setting to be replaced/or overlayed to modify the original photograph. In the embodiments of system 200 of FIG. 2, the recommender model training system 280, will access the knowledgebase, and based on the current user settings and preferences, and use the recommender model to suggest to the user particular edit to make and candidate images/photographs.

With reference to system 200 of FIG. 2, a photograph image section selection/navigation module 270 provides a tool providing the operator/editor with the ability for users to make specific edits of the image sections and image “objects” to be reworked or replaced in the photograph via respective image editing toolbars.

FIG. 5 shows one embodiment of a display interface 500 displaying a current photograph and displaying additional corresponding navigation toolbars overlayed on corresponding user selected image sections 502, 504 once an image object or section is selected by the user. The operator/editor can select one or more image sections or objects of interest, and the system generates a corresponding navigation toolbar 512, 514 for display as an overlay over the selected image section or object or near the selected image section or object of interest. In this embodiment, via a respective toolbar, 502, 504, the operator/editor can navigate the image section or object from one candidate photograph to another candidate photograph as a result of the machine learned approach to search based on user preferences without changing the main photograph 152. Each navigation toolbar provides a scrolling feature for replacing image object in focus at the selected image section by scrolling through available candidate image objects referenced by the recommender module 280 based on searches conducted in a corpus or other images source. Only the image section or object of interest in focus will be navigated. The operator/editor can use their finger, a stylus or selection tools to select an image object of interest.

While moving from one version of image object to another version of image object for the same image object, the user may desire to and has the option to replace the existing image object in focus. In one embodiment, the image object in focus can be determined by the tags, objects and section selected by the user.

FIG. 6 shows an example display of the image object navigation block that will provide an option for an operator/editor to display each candidate digital photographs as an overlay around the selected object of interest. In one embodiment, as shown in an example display 600 of FIG. 6, the image object navigation block 282 will invoke processes to overlay, via the display, the extracted image objects over the photograph 152, responsive to a selecting of any image object 601 from the photograph. The system invokes software methods that will perform image analysis and identify the same image objects available in other available photographs present on the device, in the cloud, on a server, or in social media, as specified by the user, so that the image objects 602a, 602b, . . . , 602f can be overlaid around the selected photograph.

While moving from one version of image object to another version of image object for the same image object, the user may desire to and has the option to replace the existing image object in focus. In one embodiment, the image object in focus can be determined by the tags, objects and section selected by the user.

Once the editing and replacement of the selected image object is made by the user, the system stores the available versions of the composite images for future use and allows the ability to replace different sections of the image at a later date so that selective zoom or contrast can be achieved using different rendering techniques. Each section may have two to three versions saved along with the image for future use (e.g., as compressed JPEG files).

In one embodiment, once a particular edit or replacement is made using the cognitive abilities of the system, a composite image of objects may be further generated and stored for future use to allow the ability to replace different sections of the image at a later date, e.g., so that selective zoom or contrast can be achieved using different rendering.

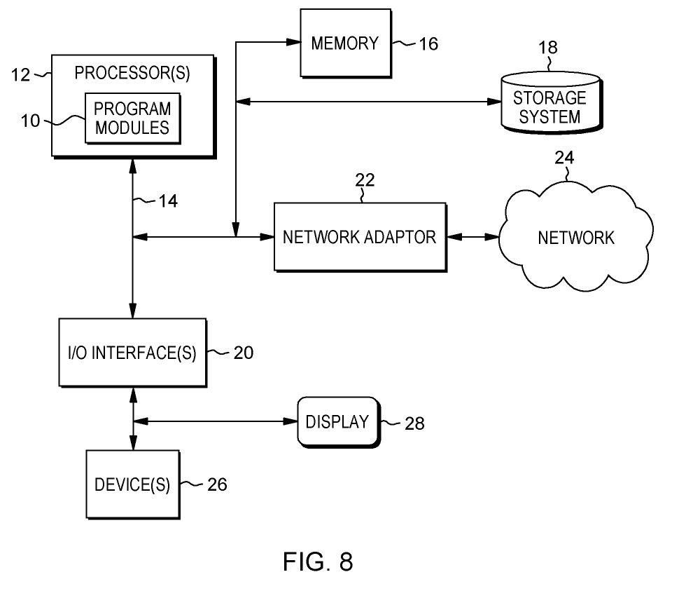

FIG. 8 illustrates an example computing system in accordance with the present invention. It is to be understood that the computer system depicted is only one example of a suitable processing system and is not intended to suggest any limitation as to the scope of use or functionality of embodiments of the present invention. For example, the system shown may be operational with numerous other general-purpose or special-purpose computing system environments or configurations. Examples of well-known computing systems, environments, and/or configurations that may be suitable for use with the system shown in FIG. 8 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

In some embodiments, the computer system may be described in the general context of computer system executable instructions, embodied as program modules stored in memory 16, being executed by the computer system. Generally, program modules may include routines, programs, objects, components, logic, data structures, and so on that perform particular tasks and/or implement particular input data and/or data types in accordance with the present invention (see e.g., FIG. 2).

The components of the computer system may include, but are not limited to, one or more processors or processing units 12, a memory 16, and a bus 14 that operably couples various system components, including memory 16 to processor 12. In some embodiments, the processor 12 may execute one or more modules 10 that are loaded from memory 16, where the program module(s) embody software (program instructions) that cause the processor to perform one or more method embodiments of the present invention. In some embodiments, module 10 may be programmed into the integrated circuits of the processor 12, loaded from memory 16, storage device 18, network 24 and/or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system may include a variety of computer system readable media. Such media may be any available media that is accessible by computer system, and it may include both volatile and non-volatile media, removable and non-removable media.

Memory 16 (sometimes referred to as system memory) can include computer readable media in the form of volatile memory, such as random access memory (RAM), cache memory an/or other forms. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

The computer system may also communicate with one or more external devices 26 such as a keyboard, a pointing device, a display 28, etc.; one or more devices that enable a user to interact with the computer system; and/or any devices (e.g., network card, modem, etc.) that enable the computer system to communicate with one or more other computing devices. Such communication can occur via Input/Output (I/O) interfaces 20.

Still yet, the computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with the computer system. Examples include, but are not limited to: microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A cognitive method for editing a digital image comprising:
receiving, at a processor device, data representing a user's selection of an object of interest within a current digital image;
receiving, at a processor device, data representing the user's preference relating to editing or replacing the selected object of interest within the current digital image;
mapping, at said processor device, said user's object of interest selection within said current digital image and said received user editing and replacing preferences to historical user editing selections and user actions associated with user selected objects of interest within digital images taken in the past;
responsive to said mapping, identifying, by said processor, a plurality of candidate digital images having similar and/or relevant objects of interest therein; and
generating, for display within said digital image, one or more identified candidate digital image section having a relevant object of interest therein, each said one or more candidate digital image sections being overlayed at a location corresponding to said user selected object of interest within said current digital image.

2. The method as claimed in claim 1, further comprising:
generating, for display with the displayed candidate digital image, an associated navigational tool bar, said navigational tool bar embedded within a portion of the candidate digital image,
said processor receiving user selections, entered via the tool bar, for navigating through the plurality of candidate digital images having similar object of interest,
wherein a user can visualize and compare different candidate digital images having an object of interest for selection without having to change the underlying current digital image.

3. The method of claim 2, further comprising:
during said navigating, receiving, at said processor device, user commands for selecting a candidate digital image having an object image selection for replacement, and
replacing, using the processor device, the user selected object of interest within said current digital image with the image of an object of interest from the selected candidate digital image to form a new composite image.

4. The method as claimed in claim 1, wherein said identifying comprises:
implementing, using said processor, image object analysis to identify a user's object of interest selection within the current digital image, and
conducting a search for candidate digital images having a similar object of interest as specified by the user.

5. The method as claimed in claim 1, wherein said identifying comprises:
implementing, by said processor, facial recognition to identify a subject within the current digital image, and
conducting a search for candidate digital images having said identified subject.

6. The method as claimed in claim 1, wherein a user preference comprises a specification of a scope of breadth search for object similarity, said identifying further comprising:
identifying, by said processor, a plurality of candidate digital images from a source of image content having similar and/or relevant objects of interest therein, said source of image content being located in a memory local to said processor or at a storage location accessible over a network.

7. The method as claimed in claim 1, wherein said mapping comprises:
running a model trained to correlate received user editing preferences and object of interest selection for a digital image with past selected image objects taken by that user historically with corresponding user's preferences and actions taken with respect to similar selected image objects stored in a knowledgebase; and
conducting a search using the trained model for generating, by said processor, said identified said plurality of candidate digital images having a similar and/or relevant object of interest therein for display.

8. A cognitive system for editing a digital image comprising:
a processing unit;
a memory coupled to the processing unit, wherein the memory stores program instructions which, when executed by the processing unit, cause the processing unit to:
receive data representing a user's selection of an object of interest within a current digital image;
receive data representing the user's preference relating to editing or replacing the selected object of interest within the current digital image;
map said user's object of interest selection within said current digital image and said received user editing and replacing preferences to historical user editing selections and user actions associated with user selected objects of interest within digital images taken in the past;
identify, in response to said mapping, a plurality of candidate digital image images having similar and/or relevant objects of interest therein; and
generate, for display within said digital image, one or more identified candidate digital image section having a relevant object of interest therein, each said one or more candidate digital image sections being overlayed at a location corresponding to said user selected object of interest within said current digital image.

9. The cognitive system as claimed in claim 8, wherein the program instructions, when executed by the processing unit, further cause the processing unit to:
generate for display with the displayed candidate digital image, an associated navigational tool bar, said navigational tool bar embedded within a portion of the candidate digital image, and
receive user selections, entered via the tool bar, for navigating through the plurality of candidate digital photograph images having similar object of interest,
wherein a user can visualize and compare different candidate digital images having an object of interest for selection without having to change the underlying current digital image.

10. The cognitive system of claim 9, wherein the program instructions, when executed by the processing unit, further cause the processing unit to:
during said navigating, receive user commands for selecting a candidate digital image having an object image selection for replacement, and replace the user selected object of interest within said current digital image with the image of an object of interest from the selected candidate digital image to form a new composite image.

11. The cognitive system as claimed in claim 8, wherein to identify, the program instructions, when executed by the processing unit, further cause the processing unit to:
implement image object analysis to identify a user's object of interest selection within the current digital image, and
conduct a search for candidate digital images having a similar object of interest as specified by the user.

12. The cognitive system as claimed in claim 8, wherein to identify, the program instructions, when executed by the processing unit, further cause the processing unit to:
implement facial recognition to identify a subject within the current digital image, and
conduct a search for candidate digital images having said identified subject.

13. The cognitive system as claimed in claim 8, wherein a user preference comprises a specification of a scope of breadth search for object similarity, wherein to identify, the program instructions, when executed by the processing unit, further cause the processing unit to:
identify a plurality of candidate digital images from a source of image content having similar and/or relevant objects of interest therein, said source of image content being located in a memory local to said processor or at a storage location accessible over a network.

14. The cognitive system as claimed in claim 8, wherein to map, the program instructions, when executed by the processing unit, further cause the processing unit to:
run a model trained to correlate received user editing preferences and object of interest selection for a digital image with past selected image objects taken by that user historically with corresponding user's preferences and actions taken with respect to similar selected image objects stored in a knowledgebase; and
conduct a search using the trained model for generating said identified said plurality of candidate digital images having a similar and/or relevant object of interest therein for display.

15. A computer program product comprising a computer-readable storage medium having a computer-readable program stored therein, wherein the computer-readable program, when executed on a computing device including at least one processing unit, causes the at least one processing unit to:
receive data representing a user's selection of an object of interest within a current digital image;
receive data representing the user's preference relating to editing or replacing the selected object of interest within the current digital image;
map said user's object of interest selection within said current digital image and said received user editing and replacing preferences to historical user editing selections and user actions associated with user selected objects of interest within digital images taken in the past;
identify, in response to said mapping, a plurality of candidate digital images having similar and/or relevant objects of interest therein; and
generate, for display within said digital image, one or more identified candidate digital image section having a relevant object of interest therein, each said one or more candidate digital
image sections being overlayed at a location corresponding to said user selected object of interest within said current digital image.

16. The computer program product as claimed in claim 15, wherein said computer-readable program configures said at least one processing unit to:
generate for display with the displayed candidate digital image, an associated navigational tool bar, said navigational tool bar embedded within a portion of the candidate digital image, and
receive user selections, entered via the tool bar, for navigating through the plurality of candidate digital images having similar object of interest,
wherein a user can visualize and compare different candidate digital images having an object of interest for selection without having to change the underlying current digital image.

17. The computer program product of claim 16, wherein said computer-readable program configures said at least one processing unit to:
during said navigating, receive user commands for selecting a candidate digital mage having an object image selection for replacement, and replace the user selected object of interest within said current digital mage with the image of an object of interest from the selected candidate digital mage to form a new composite image.

18. The computer program product as claimed in claim 15, wherein to identify, said computer-readable program configures said at least one processing unit to:
implement image object analysis to identify a user's object of interest selection within the current digital mage, and
conduct a search for candidate digital images having a similar object of interest as specified by the user.

19. The computer program product as claimed in claim 15, wherein to identify, said computer-readable program configures said at least one processing unit to:
implement facial recognition to identify a subject within the current digital mage, and
conduct a search for candidate digital images having said identified subject.

20. The computer program product as claimed in claim 15, wherein to map, said computer-readable program configures said at least one processing unit to:
run a model trained to correlate received user editing preferences and object of interest selection for a digital mage with past selected image objects taken by that user historically with corresponding user's preferences and actions taken with respect to similar selected image objects stored in a knowledgebase; and
conduct a search using the trained model for generating said identified said plurality of candidate digital images having a similar and/or relevant object of interest therein for display.
